(19) United States
(12) Patent Application Publication
(10) Pub. No.: US 2005/0023559 A1
(43) Pub. Date: Feb. 3, 2005

(54) Magnetic oxide thin film, magnetic memory element, and method of manufacturing magnetic oxide thin film

(76) Inventors: Yasushi Ogimoto, Nara-shi (JP); Kenjiro Miyano, Mitaka-shi (JP)

Correspondence Address: Edwards & Angell, LLP, P.O. Box 55874, Boston, MA, 02205, US

(21) Appl. No.: 10/897,679

(22) Filed: Jul. 22, 2004

(30) Foreign Application Priority Data
Jul. 31, 2003 (JP) 2003-204893

(51) Int. Cl. G11B 5/127

(52) U.S. Cl. 257/200

(57) ABSTRACT

In a magnetic oxide thin film, at least three phases including a layered antiferromagnetic metallic phase, an antiferromagnetic charge-ordered insulating phase, and a ferromagnetic metallic phase coexist. A magnetic memory element includes the magnetic oxide thin film and an electrode. Therefore, the magnetic oxide thin film and the magnetic memory element can attain, in a form of thin-film (which is necessary to form a device), (i) an enormous resistance change and history dependence at a low resistance and (ii) history dependence of magnetization under a weak magnetic field, without narrowing a range of operating temperature.

This nonprovisional application claims priority under 35 U.S.C. § 119(a) on Patent Application No. 2003/204893 filed in Japan on Jul. 31, 2003, the entire contents of which are hereby incorporated by reference.

### FIELD OF THE INVENTION

The present invention relates to a magnetic oxide thin film, a magnetic memory element, and a method of manufacturing the magnetic oxide thin film.

### BACKGROUND OF THE INVENTION

Recently, the digitalization of broadcasting and communications has been experiencing remarkable progresses. Accordingly, attentions are paid to storage devices compatible to broadband and large-size information such as high-quality moving images. Such storage devices under development are not only magnetic disc memories and optical disc memories, which are getting widespread primarily by being used in desktop type products, but also large-capacity solid memory elements (nonvolatile memories) intended for use in highly portable small products such as laptop computers, PDAs (Personal Digital Assistants), portable phones, and further, wearable computers.

For example, according to Nikkei Microdevices, Jan. 2003 edition (published on Jan. 1, 2003), pp.72-83, MRAMs (Magnetic RAMs) and RRAMs (Resistance RAMs) are getting attentions as new-generation nonvolatile memories that allow for high-speed access equivalent to that of DRAM (Dynamic Random Access Memories). In particular, a multi-value approach for increasing capacity of nonvolatile memories is getting more and more significant in terms of cost, because this approach does not rely solely on micro-fabrication technology.

In order to use multiple values, a sufficient margin is required, so that information can be stored via write signals corresponding to multiple values, and that each information can be discriminated at the time of reading. This means that, if an MRAM is taken as an example, a higher magnetoresistance is required in order to use multiple values.

In an MRAM, a magnetoresistance of 40% to 50% is currently attained by using a TMR (Tunneling Magneto Resistance) element that is made of magnetic alloy multi-layer film and tunneling insulating film and that has a multi-layer structure. A nonvolatile multi-valued memory element can be realized if the magnetoresistance becomes higher.

There exists another magnetoresistance whose mechanism is completely different from that of the TMR. As a material that shows an enormous magnetoresistance of several orders, oxide perovskite singlecrystalline material including manganese (Mn) is disclosed in Japanese Patent No. 2685721 (date of registration: Aug. 15, 1997), Japanese Patent No. 2812913 (date of registration: Aug. 7, 1998), and Japanese Patent No. 2812915 (date of registration: Aug. 7, 1998), for example. The oxide perovskite singlecrystalline material including manganese (Mn) is such that, when a magnetic field is applied to an antiferromagnetic charge-ordered insulating phase where Mn³⁺ ions and Mn⁴⁺ ions are in order, the antiferromagnetic charge-ordered insulating phase collapses. Therefore, a transition is made from antiferromagnetic insulator (a state in which charge is in order) to ferromagnetic metal. This is called a “switching effect” (which involves a lattice change that amounts to several percents). In this material, the magnetoresistance emerges according to this mechanism.

It is known that resistance and magnetization can be controlled in accordance with history of the magnetic field by the two-phase coexisting state comprised of the antiferromagnetic charge-ordered insulating phase and the ferromagnetic metallic phase in the perovskite manganese (Mn) oxide singlecrystalline material that shows the switching effect.

For example, according to Phys. Rev. Lett. vol.83, p.3940 (1999) (published on Nov. 8, 1999), the two phases comprised of the antiferromagnetic charge-ordered insulating phase and the ferromagnetic metallic phase is caused to coexist by replacing an Mn site with chrome (Cr). As a result, in Nd_{0.5}Ca_{0.5}Mn_{1-y}Cr_{y}O₃ (y=0.02), which is oxide perovskite monocrystal, it is possible to use multiple values, and further, to control values of resistance and magnetization in accordance with the strength and history of an externally-applied magnetic field. Moreover, recorded magnetization and resistance relax as time passes.

The inventors of the present invention reports in Appl. Phys. Lett. Vol.78, p.3505 (2001) (published on May 28, 2001) that, as in bulk monocrystal, the coexistence of the two phases is attained also in a thin-film form (which is necessary to form a device) by using a Cr doping method, and that (i) resistance change in accordance with the history of the magnetic field and (ii) the relaxation phenomenon are attained accordingly.

In Collected Drafts of 48th Applied-Physics-Related Association Lecture Meeting, spring session, 30-V-11 (2001) (published on Mar. 28, 2001), the inventors of the present invention reports on an example where the coexistence of the two phases comprised of the antiferromagnetic charge-ordered insulating phase and the ferromagnetic metallic phase is attained by a method other than the Cr doping. According to the report, the coexistence of the two phases is attained by a random field of a defect and a grain boundary attributed to a polycrystalline thin film. As a result, the resistance and magnetization change in accordance with the history of the magnetic field.

In addition, Phys. Rev. B vol.60, p.9506 (1999) (published on Oct. 1, 1999) reports that the two phases comprised of the antiferromagnetic charge-ordered insulating phase and the ferromagnetic metallic phase coexist in monocrystal of Nd_{0.51}Sr_{0.49}MnO₃, and that two phases comprised of the antiferromagnetic charge-ordered insulating phase and a layered antiferromagnetic metallic phase coexist in monocrystal of Nd_{0.49}Sr_{0.51}MnO₃.

It is expected that the coexistence of the two phases comprised of the antiferromagnetic charge-ordered insulating phase and the ferromagnetic metallic phase can realize: (i) a nonvolatile multi-valued magnetic memory element using multiple values of resistance and magnetization, and (ii) a magnetic memory that uses the relaxation phenomenon and therefore has a learning and storing function or an associating and storing function.

However, in realizing a magnetic memory element using resistance as an output, if the coexistence of the two phases comprised of the antiferromagnetic charge-ordered insulating phase and the ferromagnetic metallic phase is utilized as in conventional art, resistance under zero magnetic field is high (higher than 1 Ωcm) at temperatures in which an enormous resistance change can be obtained. Therefore, emitted heat and impedance is high during memory operation. This is a bottleneck for operating speed.

On the other hand, if the ratio of the ferromagnetic metallic phase is high (up to 0.8 μB/Mn), as in the case of the monocrystal of Nd_{0.51}Sr_{0.49}MnO₃, a maximum temperature for attaining a resistance change is low, instead of the low resistance value. As a result, there is a problem that the range of operating temperature is narrow.

That is, there is a tradeoff between (i) a condition for keeping the temperature range for attaining a resistance change broad and (ii) a condition for attaining an enormous resistance change at a low resistance value suitable for memory operation.

Moreover, in realizing a magnetic memory element using resistance as an output, there is also a problem that a magnetic field as strong as to have a magnetic flux density of several tesla is required in order to attain a magnetization change that shows history dependent properties.

### SUMMARY OF THE INVENTION

An object of the present invention is to provide a magnetic oxide thin film, a magnetic memory element, and a method of manufacturing a magnetic oxide thin film, each showing, in a form of thin-film (which is necessary to form a device), (i) an enormous resistance change and history dependence at a low resistance and (ii) history dependence of magnetization under a weak magnetic field, without narrowing a range of operating temperature.

The inventers of the present invention focused attention on magnetic structures and electric characteristics of coexisting phases, and thoroughly examined coexistence of the phases in the form of thin film. As a result, the inventers of the present invention arrived at the following invention of magnetic oxide thin film, magnetic memory element, and method of manufacturing the magnetic oxide thin film.

To attain the foregoing object, in a magnetic oxide thin film of the present invention, at least three phases including a layered antiferromagnetic metallic phase, an antiferromagnetic charge-ordered insulating phase, and a ferromagnetic metallic phase coexist.

A method of the present invention for manufacturing the magnetic oxide thin film includes the step of: adding a layered antiferromagnetic metallic phase to an antiferromagnetic charge-ordered insulating phase and a ferromagnetic metallic phase, so as to cause the layered antiferromagnetic metallic phase, the antiferromagnetic charge-ordered insulating phase, and the ferromagnetic metallic phase to coexist.

According to this invention, it is possible to provide a magnetic oxide thin film that shows, in a form of thin-film (which is necessary to form a device), (i) an enormous resistance change and history dependence at a low resistance and (ii) history dependence of magnetization under a weak magnetic field, without narrowing a range of operating temperature, and to provide a method of manufacturing the magnetic oxide thin film.

To attain the foregoing object, a magnetic memory element of the present invention includes the magnetic oxide thin film and a resistance detector.

According to this invention, it is possible to provide (i) a nonvolatile multi-valued magnetic memory element using resistance as an output or (ii) a magnetic memory element having a learning and storing function or an associating and storing function by utilizing the relaxation phenomenon.

To attain the foregoing object, a magnetic memory element of the present invention includes the magnetic oxide thin film and a magnetization detector.

According to this invention, it is possible to provide (i) a nonvolatile multi-valued magnetic memory element using magnetization as an output or (ii) a magnetic memory element having a learning and storing function or an associating and storing function by utilizing the relaxation phenomenon.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a cross-sectional view illustrating a magnetic memory element of one embodiment of the present invention, the magnetic memory element including a resistance detector.

FIG. 2 is a graph showing temperature dependency of resistivity in the magnetic memory element measured by an application of different magnetic fields respectively having the following magnetic flux densities: 0 T, 1 T, 2 T, 3 T, 4 T, 5 T, 7 T, and 9 T.

FIG. 3 is a graph showing magnetic history dependence of resistivity in the magnetic memory element measured at the temperature of 5K.

FIG. 4 is a graph showing temperature dependence of magnetization in the magnetic memory element measured by an application of different magnetic fields respectively having the following magnetic flux densities: 0.5 T, 1 T, 2 T, 3 T, 4 T, and 5 T.

FIG. 5 is a graph showing magnetic hysteresis curves of the magnetic memory element based on measurement performed at 5K by an application of different magnetic fields respectively having the following magnetic flux densities: 1 T, 3 T, and 5 T.

FIG. 6 is an enlarged view of FIG. 5.

FIG. 7 is a graph showing temperature dependence of magnetization in the magnetic memory element measured by an application of different magnetic fields of 100 Oe, 200 Oe, 500 Oe, 1000 Oe, 2000 Oe, and 5000 Oe.

FIG. 8 is a graph showing hysteresis curves of the magnetic memory element based on measurement performed at the temperature of 5K by an application of a magnetic field of 2 kOe.

FIG. 9 is a graph showing hysteresis curves of the magnetic memory element based on measurement performed at the temperature of 5K by an application of a magnetic field of 1 kOe.

FIG. 10 is a graph showing a relaxation characteristic of magnetization in the magnetic memory element at the temperature of 5K.

FIG. 11 is a graph showing a relaxation characteristic of magnetization in the magnetic memory element at the temperature of 140K.

FIG. 12 is a cross-sectional view illustrating a magnetic memory element of another embodiment of the present invention, the magnetic memory element including a magnetization detector.

### DESCRIPTION OF THE EMBODIMENTS

### Embodiment 1

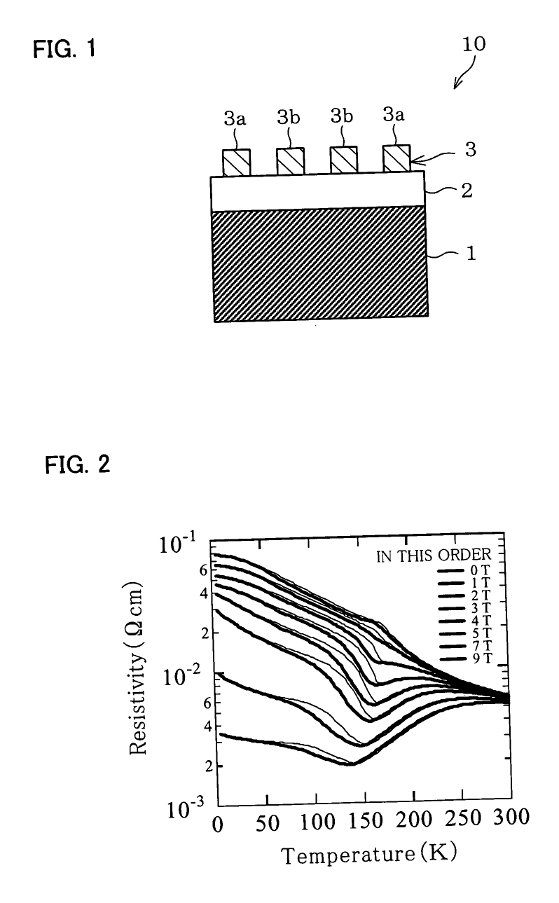

With reference to FIGS. 1 through 11, the following describes one embodiment of the present invention. Note that the purpose of the present invention is not limited in any way by the present embodiment.

A magnetic oxide thin film of the present embodiment utilizes coexistence of three phases including a layered antiferromagnetic metallic phase (A-type AFM Metal), an antiferromagnetic charge-ordered insulating phase (CE-type AFM COI), and a ferromagnetic metallic phase (FM Metal), thereby realizing (i) an enormous resistance change and history dependence at a low resistance and (ii) history dependence of magnetization under a weak magnetic field, without narrowing a range of operating temperature.

First, the mechanism for attaining the foregoing effect is described by clarifying the role of each phase played in coexistence of each two phases selected from the three kinds of phases. Then, an example of an actual Nd_{0.49}Sr_{0.51}MnO₃ thin film is discussed.

(a) The Case of Antiferromagnetic Charge-Ordered Insulating Phase and Ferromagnetic Metallic Phase

As described in the background section, an enormous resistance change and history dependence are attained by the coexistence of two phases comprised of the antiferromagnetic charge-ordered insulating phase and the ferromagnetic metallic phase. The resistance is high if no magnetic field is applied from outside. This is because the resistance of the antiferromagnetic charge-ordered insulating phase is high.

If the ratio of the ferromagnetic metallic phase is increased, antiferromagnetic order becomes weaker, thereby lowering the resistance. However, this lowers a temperature that attains a resistance change, that is, an antiferromagnetic transition temperature “T_{N}”. Therefore, the temperature range that attains a resistance change is narrowed.

On the other hand, because the antiferromagnetic phase and the ferromagnetic phase coexist magnetically, history dependence of magnetization is attained. If a complete transition occurs from the antiferromagnetic phase to the ferromagnetic phase, only the ferromagnetic phase is left. In this case, no spin frustration occurs. History dependence at a strong magnetic field is attained when the ratio between the ferromagnetic phase and the antiferromagnetic phase changes. On the other hand, history dependence under a weak magnetic field is attained by spin frustration at a boundary between the ferromagnetic phase and the antiferromagnetic phase. This phenomenon is called “spin glass” or “cluster glass”. The spin frustration means a situation where there is a competition between ferromagnetism and antiferromagnetism or the like.

(b) The Case of Layered Antiferromagnetic Metallic Phase and Antiferromagnetic Charge-Ordered Insulating Phase

The layered antiferromagnetic metallic phase is a state where spins are aligned ferromagnetically in a two-dimensional plane, and are coupled antiferromagnetically between the planes. In an in-plane direction, the layered antiferromagnetic metallic phase shows metallic conduction, and the resistance is therefore low. In an inter-plane direction, the spins are antiferromagnetic, and the resistance is therefore high.

Thus, with the combination of these two phases, the resistance is low due to the presence of the layered antiferromagnetic metallic phase, even if no magnetic field is applied from outside. The combination of these two phases is different from the ferromagnetic metallic phase in that, because the combination of these two phases is antiferromagnetic, its resistance can be lowered without lowering an overall antiferromagnetic transition temperature (T_{N}).

When a weak magnetic field is applied, the spins of the layered antiferromagnetic metallic phase start to align ferromagnetically. However, because a transport property in the in-plane direction is inherently metallic, no significant resistance change occurs at this time. If a stronger magnetic field is applied, the antiferromagnetic charge-ordered insulating phase makes a transition to the ferromagnetic phase. Thus, although the coexistence of these two phases attains a significant resistance change at a low resistance, the history dependence cannot be attained in this case.

On the other hand, although these two phases have different magnetic structures magnetically, there is only the antiferromagnetic phase. Therefore, there is hardly any spin frustration. If a magnetic field that is strong enough to cause a transition from the antiferromagnetic charge-ordered insulating phase to the ferromagnetic phase is applied, the ferromagnetic phase emerges. Therefore, spin frustration is attained by the coexistence of the antiferomagnetic phase and the ferromagnetic phase. Under a weak magnetic field, however, the spin frustration cannot be attained because such switching does not occur.

(c) The Case of Layered Antiferromagnetic Metallic Phase and Ferromagnetic Metallic Phase

Both the layered antiferromagetic metallic phase and the ferromagnetic metallic phase show metallic conduction, and the resistance is therefore low. However, because there is no charge-ordering phase, no transition from insulator to metal occurs even if a magnetic field is applied. Therefore, the resistance change is small. On the other hand, the ferromagnetic phase and the antiferromagnetic phase coexist magnetically. Therefore, spin frustration can be attained under a weak magnetic field.

As described in (a), (b), and (c), in the cases where only two phases coexist, it is impossible to simultaneously attain an optimal range of operating temperature, an enormous resistance change and its history dependence at a low resistance, and history dependence of magnetization at a weal magnetic field.

If coexistence of three phases is attained, however, it is possible to simultaneously attain (i) an enormous resistance change and its history dependence at a low resistance and (ii) history dependence of magnetization under a weak magnetic field, without narrowing a range of operating temperature. This is because, as described above, if the ferromagnetic metallic phase is added to the coexistence of two layers including the layered ferromagnetic metallic phase and the antiferromagnetic charge-ordered insulating phase, spin frustration is attained by the ferromagnetic phase and the antiferromagnetic phase, regardless of history dependence of the resistance and whether or not a magnetic field is applied.

If the layered antiferromagnetic metallic phase is made a main phase (that is, if the ratio of the layered antiferromagnetic metallic phase in the coexistence of three layers is increased more than those of other phases), a certain resistance change occurs in a wide temperature range. Moreover, if the antiferromagnetic charge-ordered insulating phase is made a main phase, it is possible to increase the resistance change.

By changing the ratios of the three phases as mentioned above, it is possible to perform an adjustment, such as flattening an output that depends on the operating temperature or expanding a margin in multiple values.

(d) Result in Nd_{0.49}Sr_{0.51}MnO₃ Polycrystalline Thin Film

To verify the foregoing mechanism, an Nd_{0.49}Sr_{0.51}MnO₃ polycrystalline thin film, in which two phases including a layered antiferromagnetic metallic phase and an antiferromagnetic charge-ordered insulating phase coexist, was manufactured. Coexistence of three phases was attained by utilizing a ferromagnetic metallic phase induced by a defect and a grain boundary in the polycrystalline thin film. Then, resistance and magnetic characteristic, which are bases of memory operation, were examined. The result is described below.

As a magnetic memory element including a resistance detector, a magnetic memory element 10 was manufactured. The schematic arrangement of the magnetic memory element 10 is shown in FIG. 1. The magnetic memory element 10 included a singlecrystalline substrate 1, a magnetic oxide thin film 2, and electrodes 3. The magnetic oxide thin film 2 was provided on the singlecrystalline substrate 1. The electrodes 3, which were to be the resistance detector, were provided on the magnetic oxide thin film 2.

By a four-terminal method, a current of 0.1 mA was supplied to an outer pair of electrodes 3a, and a voltage generated between inner pair of electrodes 3b was measured, resistivity was calculated. The electrodes 3 were made of alloy of gold and palladium, and were formed by a sputtering method. However, material for the electrodes 3 is not limited to the alloy of gold and palladium, as long as ohmic contact is possible. The ohmic contact is electrical contact between two materials, and the electrical contact is in conformity with Ohm's law [V (voltage)=I (current)×R (resistance)]. In other words, unlike Schottky contact, the ohmic contact does not have a rectifying function or the like function; the ohmic contact ensures that a current flows in both directions in the same manner.

On the single crystalline substrate 1 (made of LaAlO₃ (001), pseudocubic crystal, lattice constant: 0.379 nm), an Nd_{0.49}Sr_{0.51}MnO₃ film (thickness: 300 nm) was formed by a laser abrasion method. An average lattice constant in monocrystal of Nd_{0.49}Sr_{0.51}MnO₃ was 0.384 nm, and its lattice mismatch with the singlecrystalline substrate 1 was −1.3%. Therefore, an Nd_{0.49}Sr_{0.51}MnO₃ film was compressively strained.

Next, manufacturing process for the magnetic oxide thin film 2 is described.

As a target, a polycrystalline material manufactured by a solid-phase reaction method was used in a cylindrical shape (20 mmø), and its composition was stoichiometric. After the singlecrystalline substrate 1 was placed in a vacuum chamber, vacuum pumping was performed until a pressure of not higher than 1×10⁻⁸ Torr was attained. Then, 1 mTorr of high-purity oxygen gas was introduced, and the singlecrystalline substrate 1 was heated to 830° C. By using a KrF excimer laser (wavelength: 248 nm), the target was irradiated (power: 100 mJ at a laser beam introduction port of the chamber; cycle: 4 Hz), so as to form a thin film.

Thereafter, oxygen gas at one atmosphere was introduced into the chamber, and the temperature of the singlecrystalline substrate 1 was kept at 550° C. for 30 minutes. After annealing was performed, the singlecrystalline substrate 1 was cooled down to room temperature.

As a result of X-ray diffraction measurement, it was found that the film had grown up coherently on the singlecrystalline substrate 1 by being subjected to compressive strain caused by the singlecrystalline substrate 1. In other words, it was found that the film consisted of (i) a singlecrystalline part where the lattice constant in the in-plane direction was identical to the lattice constant of the singlecrystalline substrate 1, (ii) a polycrystalline part where the compressive strain caused by the singlecrystalline substrate 1 was relaxed partially, so that the crystal was aligned, and (iii) a polycrystalline part where the compressive strain caused by the singlecrystalline substrate 1 was relaxed completely. Thus, except the singlecrystalline part, the strain caused by the singlecrystalline substrate 1 partially remained, and there were a defect and a grain boundary attributed to the polycrystalline thin film. In the singlecrystalline film, the in-plane lattice constant “a” was 3.79 Å, which was identical to the lattice constant of the substrate. The lattice constant “c” perpendicular to the film planes was 3.93 Å, as a result of expansion (elastic deformation; c/a ratio: approximately 1.04) due to the compressive strain caused by the singlecrystalline substrate 1. The singlecrystalline film showed a transition to the antiferromagnetic phase at 160K or lower. Thus, it was found that the film had turned into antiferromagnetic insulator called C-type.

The defect and grain boundary attributed to the polycrystalline thin film function as a random field.

In a ferromagnetic phase, this function disturbs the order of spins, scatters carriers, and weakens the ferromagnetic metallic phase.

On the other hand, in a charge-ordering phase of Mn³⁺ ions and Mn⁴⁺ ions, this function disturbs the order of charges, and exists as a ferromagnetic metallic phase domain in crystal where an antiferromagnetic charge-ordered insulating phase is a main phase. In this way, the ferromagnetic phase in the coexistence of three phases is induced. Moreover, this function plays a role of a pinning, and facilitates history dependence of the resistance and magnetization under a weak magnetic field.

Moreover, due to the partial relaxation, the strain caused by the singlecrystalline substrate 1 influences the thin film. The antiferromagnetic charge-ordered insulating phase collapses, and the switching phenomenon, that is, a transition from the antiferromagnetic insulator (charge-ordering state) to the ferromagnetic metal, involves a lattice change of as high as several percent. In this case, if the lattice change is suppressed due to the fact that the in-plane lattice constants were clamped to the singlecrystalline substrate 1, such a transition cannot be attained. This problem is unavoidable if the lattice change and the charge-ordering phase emerge at the same temperature.

However, Nd_{0.49}Sr_{0.51}MnO₃ makes a transition from the paramagnetic phase to the ferromagnetic phase at approximately 240K, and further to the antiferromagnetic phase at approximately 160K. On the other hand, the lattice change occurs at 200K, which is a temperature at which the layered antiferromagnetic metal layer starts to develop. Thus, (i) the lattice change and (ii) the antiferromagnetic-ferromagetic transition and the metal insulator transition occur at different temperatures. This is because the layered antiferromagnetic metallic phase makes a transition to the antiferromagnetic phase earlier than the antiferromagnetic charge-ordered insulating phase.

The phase transition to the layered antiferromagnetic metallic phase is attained when an x²-y² orbital, which is an orbital of 3d electrons in the crystal, aligns. In the antiferromagnetic charge-ordered insulating phase, a 3x²-r² orbital and a 3y²-r² orbital, which are orbitals of the 3d electrons, are aligned. Therefore, (i) the lattice change and (ii) the magnetic and electrical transitions occur at different temperatures because the x²-y² orbital aligns earlier.

The fact that (i) the lattice change and (ii) the magnetic and resistance transitions occur at different temperatures suggests the possibility that the magnetic and resistance transitions are readily attained even if the thin film is influenced by the strain caused by the substrate 1. Such an effect is expected in the case of Nd_{0.49}Sr_{0.51}MnO₃ polycrystal.

FIG. 2 shows the temperature dependency of the resistivity of an Nd_{0.49}Sr_{0.51}MnO₃ thin film measured by an application of different magnetic fields respectively having the following magnetic flux densities: 0 T, 1 T, 2 T, 3 T, 4 T, 5 T, 7 T, and 9 T.

After a magnetic field was applied at 300K, measurement was performed while cooling the thin film down to 5K (bold lines in FIG. 2). Then, another measurement was performed while raising the temperature to 300K (thin line in FIG. 2).

As shown in FIG. 2, under zero magnetic field, the graph is bent around 160K, and the resistivity increases as the temperature decreases. The resistivity is less than 0.1 Ω Q at maximum. Thus, low resistivity is attained. As the magnetic field increases, the transportation property from 300K to 160K becomes metallic. As the temperature further decreases, the resistance increases with a clear hysteresis attributed to a first-order transition.

The thin film is different from bulk monocrystal in that the first-order transition is not clear under zero magnetic field, but becomes clear when a magnetic field is applied. This is because of the defect or the strain caused by the singlecrystalline substrate 1. This is the first example that shows with a thin film that the first-order transition can be attained even if there are such effects of repressing the random field and lattice change.

As a result, resistance changes are attained in the range of 300K to 160K (this range is higher than the transition temperature), that is, resistance changes are attained in a wider range. This is an effect not attainable with bulk. According to FIG. 2, the resistance change between the zero magnetic field at 5K and the field of 9 T magnetic flux density at 5K is more than 2200%. Thus, enormous resistance changes are successfully attained at low resistance values.

Furthermore, enormous resistivity changes of more than 1000% are attained in a wide range of up to approximately 150K. Resistivity changes of more than 100% are attained from over 160K (the transition temperature) to approximately 230K.

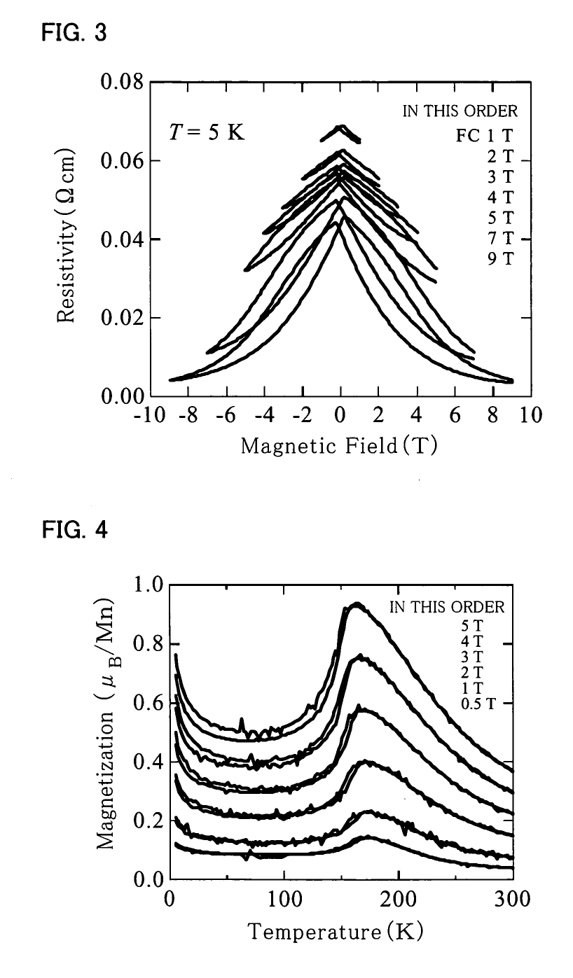

FIG. 3 shows a result of examination of the resistance change attributed to the magnetic history. FIG. 3 shows the magnetic history dependence of the resistivity at 5K. Measurement was performed as follows: (1) a magnetic field was applied at 300K; (2) the thin film was cooled down to 5K; (3) the resistance was measured while sweeping a magnetic field from the positive side to the negative side; and (4) the resistance was measured while sweeping the magnetic field again to the positive side.

The resistance value under zero magnetic field varied in accordance with the strength of the magnetic field applied at 300K. Thus, it is found that multiple values were attained. From FIG. 3, it is also frond that the hysteresis was not closed when the magnetic field had the magnetic flux density of 2 T, 3 T, 4 T, 5 T, or 7 T. This indicates that the resistance value relaxed at the time of measurement. In other words, this indicates that the magnetic history dependence attained multiple values and relaxation property.

FIG. 4 shows the temperature dependency of the magnetization of an Nd_{0.49}Sr_{0.51}MnO₃ thin film measured by an application of different magnetic fields respectively having the following magnetic flux densities: 0.5 T, 1 T, 2 T, 3 T, 4 T, and 5 T. After a magnetic field was applied at 5K, measurement was performed while raising the temperature to 300K. Then, another measurement was performed whole cooling the thin film down to 5K. The antiferromagnetic influence from the singlecrystalline substrate 1 is subtracted.

As is clear from FIG. 4, as the magnetic field becomes stronger, the ferromagnetic phase from 160K to 300K becomes clearer, and the ferromagnetic-antiferromagnetic transition at 160K becomes clearer. In addition, the magnetization value at large is augmented. This indicates that the antiferromagnetic phase and the ferromagnetic phase coexist.

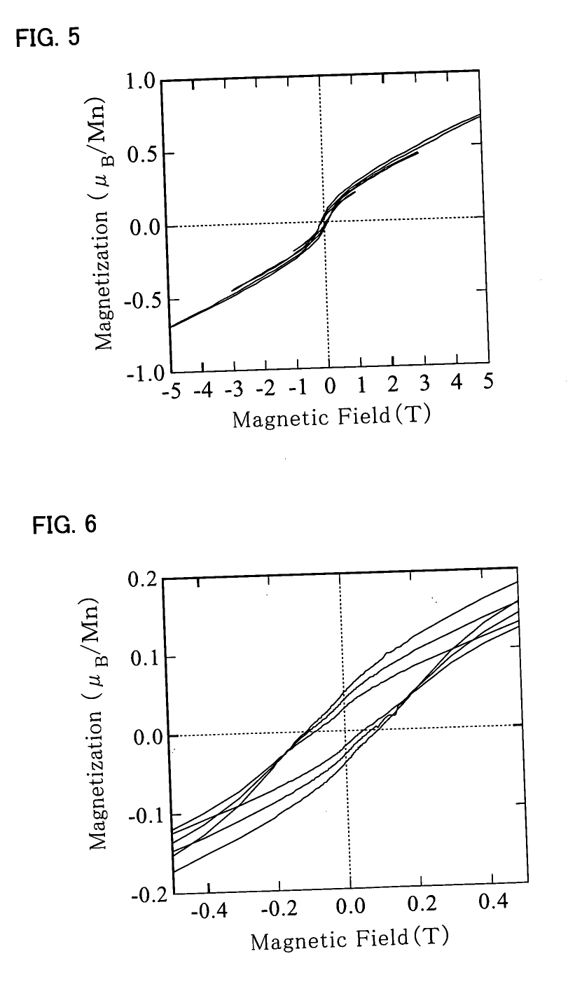

Next, FIGS. 5 through 11 respectively show results of examination of the magnetization change attributed to the magnetic field history. FIG. 5 shows hysteresis curves based on measurement by an application of different magnetic fields respectively having the following magnetic flux densities: 1 T, 3 T, and 5 T.

Measurement was performed as follows: (1) a magnetic field was applied at 300K; (2) the thin film was cooled down to 5K; (3) magnetization was measured while sweeping a magnetic field from the positive side to the negative side; and (4) magnetization was measured while sweeping the magnetic field again to the positive side.

From FIG. 5, it is found that the magnetization value changed in accordance with the strength of the magnetic field applied. It is also found that the hysteresis curves are not closed. This is consistent with the relaxation of resistance shown in FIG. 3.

FIG. 6 is an enlarged view of FIG. 5. The magnetization value under zero magnetic field changes in accordance with the strength of the magnetic field applied. Thus, multiple values are attained. Moreover, the hysteresis curves have steep gradients around the zero magnetic field. This is because of the spin frustration that occurs during coexistence of the three phases.

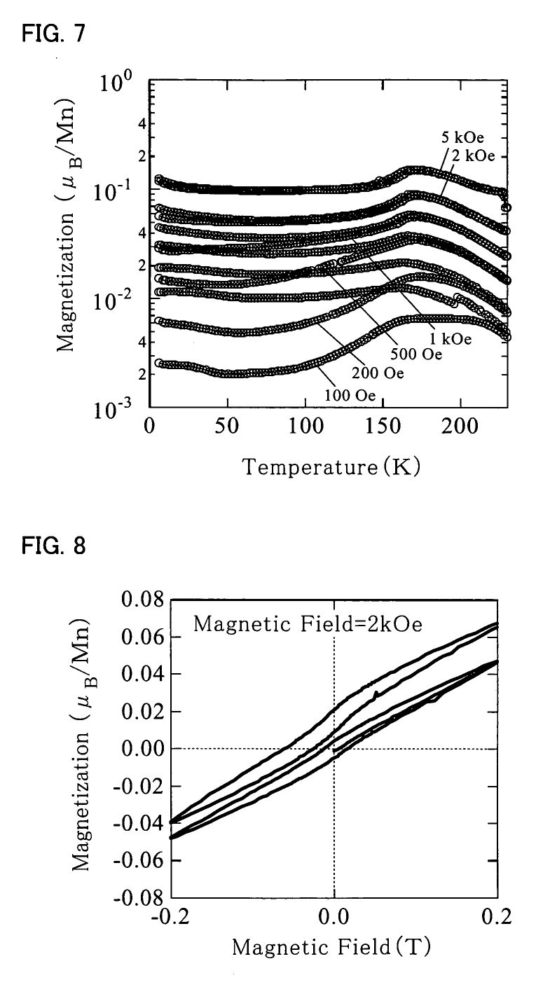

Discussed next is a result of examination of magnetic field history dependence of magnetization attributed to the spin frustration at weak magnetic fields. FIG. 7 shows temperature dependence of magnetization by an application of different magnetic fields of 100 Oe, 200 Oe, 500 Oe, 1000 Oe, 2000 Oe, and 5000 Oe (10000 Oe=1 T).

After a magnetic field was applied at 5K, the magnetization was measured for a first time while raising the temperature to 250K, and then for a second time while dropping the temperature again to 5K. At a weak magnetic field of 1 kOe or less, the magnetization value measured while the temperature was rising and the magnetization value measured while the temperature was falling were different. Specifically, the magnetization value measured while the temperature was falling was higher than the magnetization value measured while the temperature was rising. The higher the magnetic field was, the lower the bifurcation temperature was. The bifurcation temperature is such a temperature at which a magnification change occurs. For example, at the magnetic field of 100 Oe, the bifurcation temperature of magnification was 240K. This is a temperature at which the ferromagnetic phase emerges. On the other hand, the bifurcation temperature was as low as approximately 100K at the magnetic field of 1 kOe.

This result attains multiple values of magnetization and the magnetic field history characteristic at a weaker magnetic field.

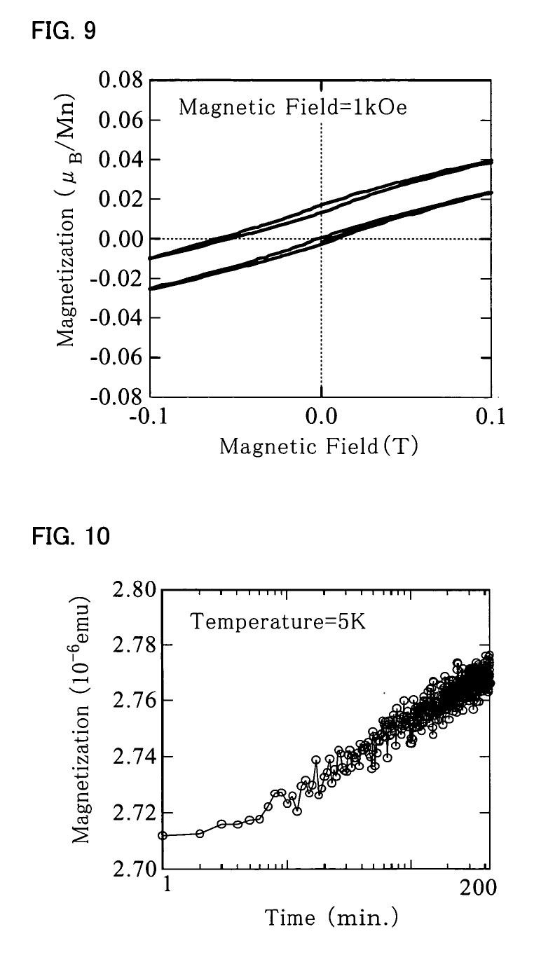

FIGS. 8 and 9 show results of examination of magnetic hysteresis at weak magnetic fields. Two kinds of measurement with different magnetic histories were performed. In one measurement, the hysteresis was measured after a magnetic field was applied at 300K and the thin film was cooled down to 5K. In the other measurement, the hysteresis was measured after the thin film was cooled down to 5K under zero magnetic field. FIG. 8 shows hysteresis curves of the case where the magnetic field was 2 kOe. FIG. 9 shows hysteresis curves of the case where the magnetic field was 1 kOe.

As shown in FIGS. 8 and 9, the hysteresis curve shifted in the vertical axis direction when the thin film was cooled down while the magnetic field was applied. As is clear from the comparison of FIG. 8 and FIG. 9, the weaker the magnetic field was, the more salient the shift was. When (i) the residual magnetization obtained from the hysteresis curves of the case where the thin film was cooled down under zero magnetic field is compared with (ii) the residual magnetization obtained from the hysteresis curves of the case where the thin film was cooled down after the application of magnetic field, there is a significant shift. Therefore, it is found that the multiple values and history dependence of magnetization were attained.

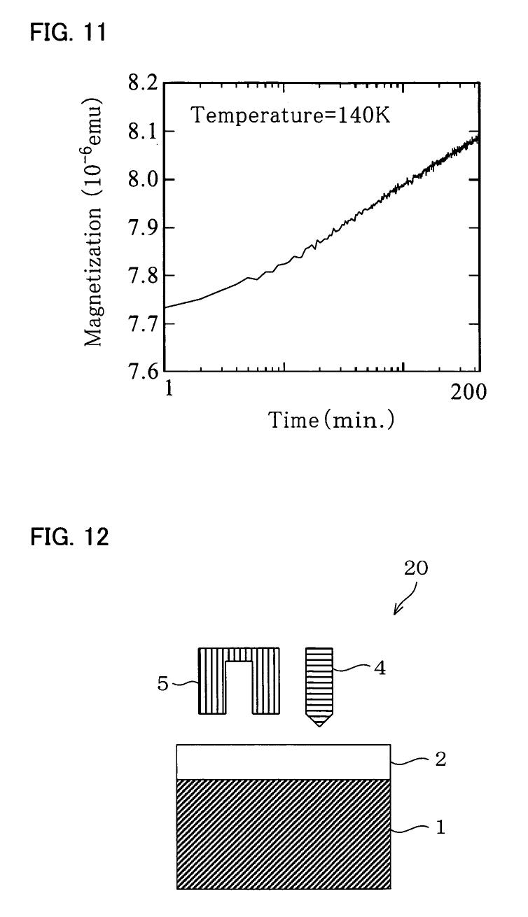

Finally, FIGS. 10 and 11 show results of examination of a relaxation characteristic of magnetization. FIG. 10 shows the relaxation characteristic at 5K, and FIG. 11 shows the relaxation characteristic at 140K. The horizontal axis is a logarithmic scale indicating time. The vertical axis is magnetization. Although the magnetization is not subjected to substrate correction, it is sufficient to consider the magnetization change. Measurement was performed by an application of the magnetic field of 200 Oe after the temperature was cooled down under zero magnetic field from room temperature to measurement temperatures (5K and 140K).

The margin of magnetization change varied in accordance with the temperature. However, in both cases the changes occurred logarithmically with respect to time. Therefore, it is found that the relaxation characteristic of magnetization was attained.

As described above, a magnetic oxide thin film that shows (i) an enormous resistance change and history dependence at a low resistance and (ii) history dependence of magnetization under a weak magnetic field can be realized without narrowing a range of operating temperature. This is made possible by utilizing the coexistence among the three phases including the layered antiferromagnetic metallic phase, the antiferromagnetic charge-ordered insulating phase, and the ferromagnetic metallic phase.

As a result, it is possible to provide (i) a nonvolatile multi-valued magnetic memory element using resistance as an output or (ii) a magnetic memory element having a learning and storing function or an associating and storing function by utilizing the relaxation phenomenon.

It is also shown that (i) an antiferromagnetic-ferromagnetic transition (first order transition) and (ii) a resistance change involving hysteresis can be realized with a thin film even if there is an influence of the strain caused by the singlecrystalline substrate 1. This is attained if the layered antiferromagnetic metallic phase makes a transition to the antiferromagnetic phase earlier than the antiferromagnetic charge-ordering phase, when the ferromagnetic phase or the paramagnetic phase makes a transition to the antiferromagnetic phase at the antiferromagnetic transition temperature.

Furthermore, the inventors of the present invention found the shift phenomenon of the magnetic hysteresis in the magnetization axis direction attributed to the spin frustration under a weak magnetic field. To the best of the inventers' knowledge, this is entirely new history dependence that makes it possible to attain a larger magnetization change under a weak magnetic field.

One of the easiest recording and erasing methods is as follows.

Recording is performed by raising the temperature to be equal to or higher than the transition temperature, applying a magnetic field of such strength that is in accordance with data to be recorded, and cooling the temperature down to the operating temperature. On the other hand, erasing is performed by raising the temperature to be equal to or higher than the transition temperature under zero magnetic field. Recorded contents do not change through reproduction. Therefore, non-destructive reading is possible. In order to raise the temperature, a heat-emitting element using a resistor, or light radiation may be used.

The material and thickness of the thin film, the substrate, and the method of manufacturing the thin film are not limited to those described in the present embodiment. In order to attain a resistance change, the magnetic field may be weakened by means of bias current or bias voltage. Moreover, a high-transition-temperature material may be used so as to improve the operating temperature.

If, for example, YBaMn₂O₆, HoBaMn₂O₆, DyBaMn₂O₆, TbBaMn₂O₆, or Bi_{0.5}Sr_{0.5}MnO₃ is used as the thin film, operation at room temperature is possible.

In the present embodiment, the coexistence of the three phases including the layered antiferromagnetic metallic phase, the antiferromagnetic charge-ordered insulating phase, and the ferromagnetic metallic phase is described. However, it is sufficient if the three phases including the layered antiferromagnetic metallic phase, the antiferromagnetic charge-ordered insulating phase, and the ferromagnetic metallic phase in the magnetic oxide thin film 2 coexist in the end.

### Embodiment 2

With reference to FIG. 12, the following describes another embodiment of the present invention. Note that the purpose of the present invention is not limited in any way by the present embodiment.

As a magnetic memory element having a magnetization detector, a magnetic memory element 20 having a schematic arrangement shown in FIG. 12 is manufactured.

As in Embodiment 1, a magnetic oxide thin film 2 is provided on a singlecrystalline substrate 1. The magnetic oxide thin film 2 is the Nd_{0.49}Sr_{0.51}MnO₃ film described in Embodiment 1. The magnetic memory element 20 further includes a magnetism probe 4 and magnetic force generating means 5. The magnetism probe 4 is a magnetization detector used in a magnetic force microscope.

The same method described in Embodiment 1 can be used to perform recording and erasing. Recording is performed by raising the temperature to be equal to or higher than the transition temperature, applying a magnetic field of such strength that is in accordance with data to be recorded, and cooling the temperature down to the operating temperature. On the other hand, erasing is performed by raising the temperature to be equal to or higher than the transition temperature under zero magnetic field. Reproduction is performed by detecting magnetization by using the magnetism probe 4. In order to raise the temperature, a heat-emitting element using a resistor, or light radiation may be used.

The magnetic force generating means 5 may be a magnetic-field-generating conducting wire provided on the singlecrystalline substrate 1. With this arrangement, it is possible to realize (i) a nonvolatile multi-valued magnetic memory element using magnetization as an output or (ii) a magnetic memory element having a learning and storing function or an associating and storing function by utilizing the relaxation phenomenon.

In the magnetic oxide thin film 2, the ferromagnetic metallic phase may be induced by a defect and by disorder attributed to a grain boundary in a polycrystalline thin film.

With this arrangement, the defect plays a role of a pinning, thereby more effectively attaining history dependence of the resistance and magnetization under a weak magnetic field.

In the magnetic oxide thin film 2, the layered antiferromagnetic metallic phase may be a main phase.

With this arrangement, an almost constant resistance change can be attained at a low resistance and in a wider temperature range.

In the magnetic oxide thin film 2, the antiferromagnetic charge-ordered insulating phase may be a main phase.

With this arrangement, the resistance is low, and the resistance change can be improved further.

The magnetic oxide thin film 2 may be the foregoing magnetic oxide thin film, wherein the layered antiferromagnetic metallic phase makes a transition to the antiferromagnetic phase earlier than the antiferromagnetic charge-ordering phase, when a ferromagnetic phase or a paramagnetic phase makes a transition to an antiferromagnetic phase at a substantially antiferromagnetic transition temperature.

With this arrangement, the switching is possible even if there is a lattice change in a partially relaxed polycrystalline thin film.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A magnetic oxide thin film, wherein:
at least three phases including a layered antiferromagnetic metallic phase, an antiferromagnetic charge-ordered insulating phase, and a ferromagnetic metallic phase coexist.

2. The magnetic oxide thin film as set forth in claim 1, wherein:
the ferromagnetic metallic phase is induced by a defect and by disorder attributed to a grain boundary in a polycrystalline thin film.

3. The magnetic oxide thin film as set forth in claim 1, wherein:
the layered antiferromagnetic metallic phase is a main phase.

4. The magnetic oxide thin film as set forth in claim 1, wherein:
the antiferromagnetic charge-ordered insulating phase is a main phase.

5. The magnetic oxide thin film as set forth in claim 1, wherein:
the layered antiferromagnetic metallic phase makes a transition to an antiferromagnetic phase earlier than the antiferromagnetic charge-ordered insulating phase, when a ferromagnetic phase or a paramagnetic phase makes a transition to an antiferromagnetic phase at a substantially antiferromagnetic transition temperature.

6. A magnetic memory element, comprising:
the magnetic oxide thin film as set forth in claim 1; and
resistance detecting means.

7. A magnetic memory element, comprising:
the magnetic oxide thin film as set forth in claim 1; and
magnetization detecting means.

8. A method of manufacturing a magnetic oxide thin film, comprising the step of:
adding a layered antiferromagnetic metallic phase to an antiferromagnetic charge-ordered insulating phase and a ferromagnetic metallic phase, so as to cause the layered antiferromagnetic metallic phase, the antiferromagnetic charge-ordered insulating phase, and the ferromagnetic metallic phase to coexist.
